(19) United States
(12) Patent Application Publication
(10) Pub. No.: US 2025/0149597 A1
(43) Pub. Date: May 8, 2025

(54) ANODELESS ELECTRODE FOR ALL-SOLID-STATE SECONDARY BATTERY, BATTERY INCLUDING THE ELECTRODE, AND METHOD FOR MANUFACTURING THE SAME

(71) Applicant: ELECTRONICS AND TELECOMMUNICATIONS RESEARCH INSTITUTE, Daejeon (KR)

(72) Inventors: Dong Ok SHIN, Daejeon (KR); Young-Gi LEE, Daejeon (KR); Seong Eun JO, Daejeon (KR); Seok Hun KANG, Daejeon (KR); YOUNG SAM PARK, Daejeon (KR); Jaecheol CHOI, Daejeon (KR)

(21) Appl. No.: 18/825,769

(22) Filed: Sep. 5, 2024

(30) Foreign Application Priority Data
Nov. 7, 2023 (KR) 10-2023-0153129
Mar. 5, 2024 (KR) 10-2024-0031570

(51) Int. Cl. H01M 4/66; H01M 4/02; H01M 4/04

(52) U.S. Cl. CPC H01M 4/667; H01M 4/0404; H01M 4/662; H01M 4/668; H01M 2004/021; H01M 2004/027

(57) ABSTRACT

Provided is an anodeless electrode, and more particularly, to an anodeless electrode including a current collector, and a conductive flexible thin-film layer disposed on the current collector. The conductive flexible thin-film layer includes a conductive polymer, a soft polymer, and metal nanoparticles. The metal nanoparticles have a diameter of about 20 nm to about 100 nm, and are contained in an amount of about 20 wt % to about 50 wt % with respect to the sum of weights of the conductive polymer and the soft polymer.

### CROSS-REFERENCE TO RELATED APPLICATIONS

This U.S. non-provisional patent application claims priority under 35 U.S.C. § 119 of Korean Patent Application Nos. 10-2023-0153129, filed on Nov. 7, 2023, and 10-2024-0031570, filed on Mar. 5, 2024, the entire contents of which are hereby incorporated by reference.

### BACKGROUND

The present disclosure herein relates to an anodeless electrode, an all-solid-state secondary battery including the electrode, and a method for manufacturing the same.

Studies are being conducted on an all-solid-state secondary battery to ensure battery stability. The all-solid-state secondary battery is a battery in which a solid electrolyte, which is non-flammable and has a relatively high rigidity, is used in place of a flammable liquid electrolyte. The all-solid-state secondary battery is advantageous in improving safety through suppression of leakage, ignition, explosion, etc., and physically inhibiting formation of lithium dendrites. However, the all-solid-state secondary battery is disadvantageous in that during charging and discharging, lithium is deposited in spaces in a solid electrolyte caused by cracking, and lithium is thus consumed.

At present, graphite which exhibits stable performance as a negative electrode but has a relatively low capacity (about 372 mAh/g) is commercially used for a secondary battery. Also, a lithium metal (about 3860 mAh/g), the capacity of which is about 10 times or more than that of graphite, is emerging as a promising negative electrode material for a high-energy-density electrode. However, since the lithium metal itself is unstable and highly reactive, it is highly likely to cause potential explosion and fire incidents. Additionally, due to non-uniform deposition of the lithium metal during charging and discharging, dendrites are easily formed and penetrate a separator, thereby leading to an internal short circuit. Furthermore, the lithium metal has a disadvantage of short lifetime due to large lithium loss when used as a negative electrode material.

To overcome the above-described disadvantages of the lithium metal, studies are being conducted on a method of treating lithium surfaces with an organic/inorganic material, a method of forming a three-dimensional electrode structure, or a method of introducing an additive to an electrolyte to control the reactivity of lithium and the formation of dendrites.

Recently, studies are being conducted on an all-solid-state secondary battery successfully operated by applying, as a negative electrode of the all-solid-state secondary battery, an anodeless electrode in which a carbon or silver (Ag) layer having a thickness of about 5 μm is formed on a current collector. The anodeless electrode means a negative electrode which is based on a current collector in which lithium is absent, a substrate capable of storing lithium is absent, or only an extremely small amount of lithium (an N/P ratio (a value obtained by dividing a total capacity of a negative electrode by a total capacity of a positive electrode)<0.1) is applied.

The anodeless electrode currently being studied is advantageous in that it is possible to achieve a high energy density due to the absence of lithium or negative electrode materials. However, the anodeless electrode has a disadvantage of energy density loss since an additional layer having a thickness of several um and not contributing to capacity is used. Additionally, the anodeless electrode is disadvantageous in that due to low mechanical flexibility and elasticity, fatigue, cracking, and breaking may occur at an interface between a solid electrolyte and an electrode during operation of an all-solid-state secondary battery. It is challenging to apply a flexible substrate to the above-described anodeless electrode, which also makes it difficult to achieve a flexible power source.

Therefore, a conductive flexible thin-film layer having a thickness of um or less is demanded in order to substantially improve an energy density and form a stable interface between a solid electrolyte and an electrode.

### SUMMARY

The present disclosure herein relates to an anodeless electrode with which non-uniform deposition of lithium is prevented and stable charging/discharging behaviors and a large specific capacity are achieved, and a secondary battery including the same.

An embodiment of the inventive concept provides an anodeless electrode comprising: a current collector; and a conductive flexible thin-film layer disposed on the current collector, wherein the conductive flexible thin-film layer includes a conductive polymer, a soft polymer, and metal nanoparticles, and the metal nanoparticles have a diameter of about 20 nm to about 100 nm, and are contained in an amount of about 20 wt % to about 50 wt % with respect to the sum of weights of the conductive polymer and the soft polymer.

In an embodiment, the current collector may include at least one of copper, aluminum, nickel, stainless steel, titanium, or zinc.

In an embodiment, the conductive polymer may include at least one of polypyrrole (PPy), polyaniline (PANi), polythiophene (PT), poly (3,4-ethylene dioxythiophene (PEDOT), polyphenylene (PSS), poly (p-phenylene vinylene (PPV), polyacetylene (PAc), poly (3-alkylthiophene (P3ATs), or polyfuran (Pfu).

In an embodiment, the soft polymer may include at least one of butadiene rubber, fluorine-based rubber, nitrile butadiene rubber, hydrogenated nitrile butadiene rubber, styrene butadiene rubber, styrene butadiene styrene, styrene ethylene butadiene styrene, acrylated styrene butadiene rubber, or an acrylonitrile butadiene styrene copolymer

In an embodiment, the metal nanoparticles may include at least one of gold, silver, platinum, palladium, iron, cobalt, zinc, aluminum, tungsten, or silicon.

In an embodiment, the anodeless electrode may include a lithium layer, wherein the lithium layer may be disposed between the current collector and the conductive flexible thin-film layer, and have a thickness of about 100 nm to about 1 μm.

In an embodiment, the soft polymer may be contained in an amount of about 20 wt % to about 50 wt % with respect to a weight of the conductive polymer.

In an embodiment, the conductive flexible thin-film layer may have a thickness of about 50 nm to about 500 nm.

In an embodiment of the inventive concept, a secondary battery includes: an anodeless electrode including a current collector, and a conductive flexible thin-film layer disposed on the current collector; a composite positive electrode; and a solid electrolyte disposed between the anodeless electrode and the composite positive electrode, wherein the conductive flexible thin-film layer includes a conductive polymer, a soft polymer, and metal nanoparticles, and the metal nanoparticles have a diameter of about 20 nm to about 100 nm, and are contained in an amount of about 20 wt % to about 50 wt % with respect to the sum of weights of the conductive polymer and the soft polymer.

In an embodiment, the anodeless electrode may further include a lithium layer, the lithium layer is disposed between the current collector and the conductive flexible thin-film layer, and a ratio of a charging capacity of the anodeless electrode and a charging capacity of the composite positive electrode satisfies the following Expression (1). That is, an N/P ratio of the anodeless electrode may be less than about 0.1.

$$0 < a / b < 0.1 \qquad Expression ( 1 )$$

where a may denote the charging capacity (mAh) of the anodeless electrode, and b may denote the charging capacity (mAh) of the composite positive electrode.

In an embodiment of the inventive concept, a method for manufacturing an anodeless electrode includes: preparing a polymer blend by mixing a conductive polymer and a soft polymer; preparing a composite blend by mixing metal nanoparticles and the polymer blend; and coating a current collector with the composite blend, wherein the metal nanoparticles have a diameter of about 20 nm to about 100 nm, the soft polymer is mixed in an amount of about 20 wt % to about 50 wt % with respect to a weight of the conductive polymer, and the metal nanoparticles are mixed in an amount of about 20 wt % to about 50 wt % with respect to a weight of the polymer blend.

In an embodiment, the composite blend may have a thickness of about 50 nm to about 500 nm.

In an embodiment of the inventive concept, a method for manufacturing a secondary battery includes: preparing a polymer blend by mixing a conductive polymer and a soft polymer; preparing a composite blend by mixing metal nanoparticles with the polymer blend; preparing an anodeless electrode by coating a current collector with the composite blend; preparing a solid electrolyte layer; preparing a composite positive electrode on one surface of the solid electrolyte layer; and attaching the anodeless electrode to another surface, of the solid electrolyte layer, facing the one surface, wherein the metal nanoparticles have a diameter of about 20 nm to about 100 nm, the soft polymer is mixed in an amount of about 20 wt % to about 50 wt % with respect to a weight of the conductive polymer, and the metal nanoparticles are mixed in an amount of about 20 wt % to about 50 wt % with respect to a weight of the polymer blend.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1A illustrates a cross section of an anodeless electrode according to an embodiment of the inventive concept;

FIG. 1B schematically illustrates a conductive flexible thin-film layer according to an embodiment of the inventive concept;

FIG. 2A illustrates a cross section of an anodeless electrode according to Example 1-1 on which a solid electrolyte is stacked;

FIG. 2B is an enlarged view of region B of FIG. 2A;

FIG. 3A illustrates a cross section of an anodeless electrode according to Example 1-2 on which a solid electrolyte is stacked;

FIG. 3B is an enlarged view of region C of FIG. 3A;

FIG. 4A illustrates a cross section of an anodeless electrode according to Comparative Example 1-1 on which a solid electrolyte is stacked;

FIG. 4B is an enlarged view of region A of FIG. 4A;

FIG. 5A illustrates a cross section of an all-solid-state full battery according to Example 3-1;

FIG. 5B illustrates a cross section of the all-solid-state full battery according to Example 3-1 after being charged once;

FIG. 5C illustrates a cross section of the all-solid-state full battery according to Example 3-1 after being charged and discharged once;

FIG. 6A illustrates a cross section of an all-solid-state full battery according to Example 3-2;

FIG. 6B illustrates a cross section of the all-solid-state full battery according to Example 3-2 after being charged once;

FIG. 6C illustrates a cross section of the all-solid-state full battery according to Example 3-2 after being charged and discharged once;

FIG. 7A illustrates a cross section of an all-solid-state full battery according to Comparative Example 3-1;

FIG. 7B illustrates a cross section of the all-solid-state full battery according to Comparative Example 3-1 after being charged once;

FIG. 7C illustrates a cross section of the all-solid-state full battery according to Comparative Example 3-1 after being charged and discharged once;

FIGS. 8A, 8B, 8C, and 8D respectively show results of nucleation overvoltages in a first cycle during the operations of all-solid-state half batteries according to Example 2-1, Example 2-2, Comparative Example 2-1, and Comparative Example 2-2;

FIGS. 9A, 9B, and 9C respectively show results of voltage curves according to time elapse during the charging and discharging of all-solid-state half batteries according to Example 2-1, Comparative Example 2-1, and Comparative Example 2-2; and

FIGS. 10A, 10B, and 10C respectively show voltage change curves according to specific capacities of all-solid-state full batteries according to Comparative Example 3-1, Example 3-1, and Example 3-2, at various current densities.

### DETAILED DESCRIPTION

In order to fully understand the elements and effects according to embodiments of the inventive concept, preferred embodiments of the inventive concept will be described with reference to the attached drawings. However, the inventive concept is not limited to the embodiments to be disclosed below, and may be implemented in various modifications or have various forms. The description according to the embodiments is merely provided to make the complete disclosure of the inventive concept, and to fully inform one skilled in the art of the technical scope of the inventive concept. In the attached drawings, the dimensions of the elements illustrated in the drawings are enlarged than actual for convenience of description, and a ratio of each of the elements may be exaggerated or diminished.

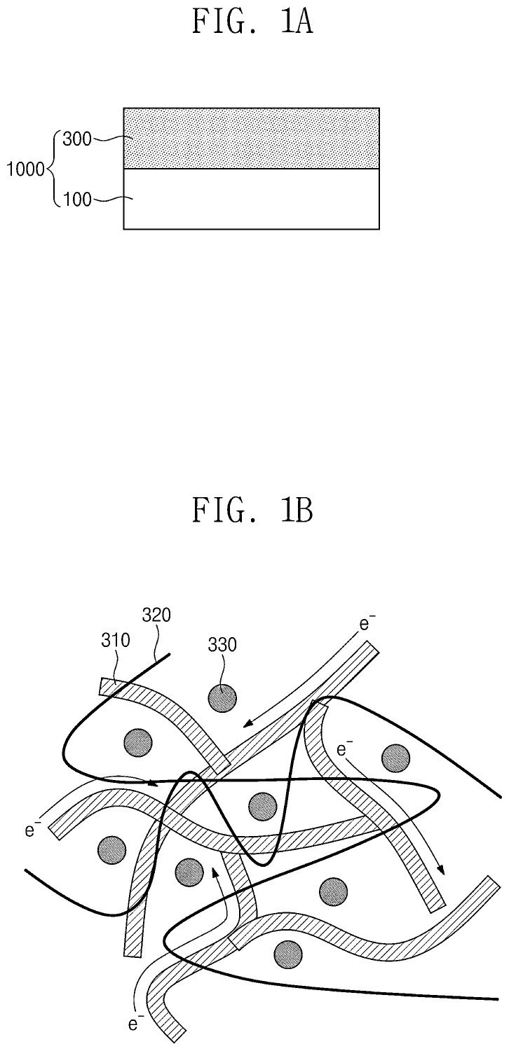

FIG. 1A illustrates a cross section of an anodeless electrode according to an embodiment of the inventive concept.

An anodeless electrode 1000 according to an embodiment of the inventive concept may include a current collector 100, and a conductive flexible thin-film layer 300 disposed on the current collector.

FIG. 1B schematically illustrates a conductive flexible thin-film layer according to an embodiment of the inventive concept.

Referring to FIG. 1B, the conductive flexible thin-film layer according to embodiments of the inventive concept may include a conductive polymer, a soft polymer, and metal nanoparticles.

In the conductive flexible thin-film layer 300, a soft polymer 320 may be contained in an amount of about 20 wt % to about 50 wt % with respect to a weight of a conductive polymer 310. Metal nanoparticles 330 may be contained in an amount of about 20 wt % to about 50 wt % with respect to the sum of weights of the conductive polymer 310 and the soft polymer 320.

The conductive polymer 310 may include an aqueous or non-aqueous material. For example, the conductive polymer 310 may include at least one of polypyrrole (PPy), polyaniline (PANi), polythiophene (PT), poly (3,4-ethylene dioxythiophene (PEDOT), polyphenylene (PSS), poly (p-phenylene vinylene (PPV), polyacetylene (PAc), poly (3-alkylthiophene (P3ATs), or polyfuran (Pfu). The soft polymer 320 may include an aqueous or non-aqueous material.

For example, the soft polymer 320 may include at least one of butadiene rubber, fluorine-based rubber, nitrile butadiene rubber, hydrogenated nitrile butadiene rubber, styrene butadiene rubber, styrene butadiene styrene, styrene ethylene butadiene styrene, acrylated styrene butadiene rubber, or an acrylonitrile butadiene styrene copolymer.

To introduce the conductive flexible thin-film layer 300 having a minimum thickness, the metal nanoparticles 330 may have a diameter of about 1 nm to about 100 nm, about 20 nm to about 50 nm, or about 20 nm to about 30 nm. When the metal nanoparticles 330 have a diameter of about 1 μm or more, the anodeless electrode 1000 according to an embodiment of the inventive concept may have a thickness of about 5 μm or more, and may thus be disadvantageous in terms of energy density. In an embodiment of the inventive concept, the metal nanoparticles 330 have a diameter of about 100 nm or less, and adoption of the metal particles having such a diameter makes the anodeless electrode be advantageous in terms of energy density.

The metal nanoparticles 330 may include at least one of gold (Au), silver (Ag), platinum (Pt), palladium (Pd), iron (Fe), cobalt (Co), zinc (Zn), aluminum (Al), tungsten (W), or silicon (Si). The above-described elements may be used alone for the metal nanoparticles 330. Alternatively, the metal nanoparticles 330 may be used in an alloy or oxide form.

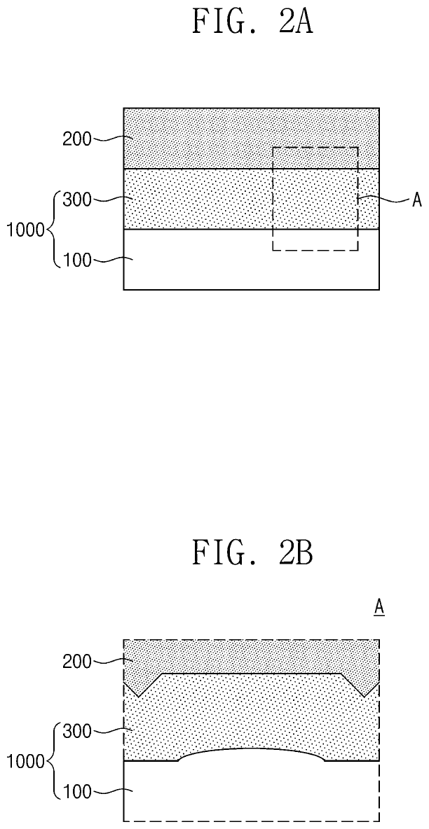

FIG. 2A illustrates a cross section of an anodeless electrode according to Example 1-1 on which a solid electrolyte is stacked. FIG. 2B is an enlarged view of region A of FIG. 2A.

Referring to FIGS. 2A and 2B, an anodeless electrode 1000 according to Example 1-1 may include a conductive flexible thin-film layer 300 on a current collector 100. That is, when a solid electrolyte 200 is disposed on the anodeless electrode 1000, the conductive flexible thin-film layer 300 may be disposed between the current collector 100 and the solid electrolyte 200.

For example, the current collector 100 may include at least one of stainless steel (SUS), copper (Cu), nickel (Ni), titanium (Ti), aluminum, zinc, or carbon. The above-described compounds may be used alone or in an alloy or oxide form. The current collector 100 may have a thickness of about 5 μm to about 20 μm, or about 7 μm to about 15 μm.

The solid electrolyte 200 may include at least one of an oxide-based solid electrolyte, a phosphate-based solid electrolyte, a sulfide-based solid electrolyte, a halogen-based solid electrolyte, or a polymer-based solid electrolyte.

The oxide-based solid electrolyte may be a compound having a garnet structure of a composition of Li_{7-3x+y-z}AₓLa_{3-y}B_{y}Zr_{2-z}C_{z}O₁₂ (A=Al, Ga/B=Ca, Sr, Ba/C=Ta, Nb, Sb, Bi). Alternatively, the oxide-based solid electrolyte may be a material having a perovskite structure of Li₃ₓLa_{(2/3)-x}□_{(1/3)-2x}TiO₃ (LLTO, 0<x<0.16, □: Vacancy). A compound, in which, in Li₇₋ₓAₓLa₃Zr₂O₁₂, about 0.3 mol of Al or Ga is doped at the Li position, or doping about 0.3 mol of Nb or Ta is doped at the Zr position, may be selected as the oxide-based solid electrolyte.

The phosphate-based solid electrolyte may be a compound having a NAISICON structure of Li₁₊ₓAlₓTi₂₋ₓ(PO₄)₃ (x=0 to 0.4).

The sulfide-based solid electrolyte may be selected from a compound group containing a chalcogenide element and lithium. The sulfide-based solid electrolyte may include at least one of a Li_{10±1}MP₂X₁₂ (M is Ge, Si, Sn, Al, or P, and X is S or Se) compound, a Li₄₋ₓSn₁₋ₓAsₓS₄ (x is 0 or 1) compound, a thio-lithium superionic conductor (thio-LISCON) compound, a Li-argyrodite-type Li₆PS₅X (X is Cl, Br, or I) compound, or an xLi₂S(100−x)P₂S₅ (x is 0 to 100) compound having a glass-ceramic structure. Alternatively, the sulfide-based solid electrolyte may include at least one of Li₂SSiS₂Li₃N, Li₂SP₂S₅LiI, Li₂SSiS₂LiₓMO_{y}, Li₂SGeS₂, or Li₂SB₂S₃LiI.

The Li_{10±1}MP₂X₁₂ compound may be a Li₁₀SnP₂S₁₂ compound. The thio-LISCON compound may be a Li_{3.25}Ge_{0.25}P_{0.75}S₄ or Li₁₀GeP₂S₁₂ compound. The Li₆PS₅X (X is Cl, Br, or I) compound may be a Li₆PS₅Cl compound. The xLi₂S(100−x)P₂S₅ (x=0 to 100) compound having the glass-ceramic structure may be a Li₂SP₂S₅ compound.

The halogen-based solid electrolyte may include at least one of Li₃ErX₆, Li₃GdX₆, Li₃ YX₆, Li₃ YX₆, or Li₃InX₆ (X is I, Cl, or Br).

The polymer-based solid electrolyte may include at least one of polyethylene oxide (PEO), polyvinyl chloride (PVC), polyacrylonitrile (PAN), poly (methyl methacrylate) (PMMA), polyvinylidene fluoride (PVDF), or a polyvinylidene fluoride-hexafluoropropylene (P (VDF-HFP)) copolymer. The polymer-based solid electrolyte may further include a lithium salt. The lithium salt may include at least one of LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, LiSCN, LiC(CF₃SO₂)₃, (CF₃SO₂)₂NLi, LiFSI, LiTFSI, LiBETI, LiBPB, LICTFSI, LiTDI, or LiPDI.

The conductive flexible thin-film layer 300 may have a thickness of about 50 nm to about 500 nm, about 100 nm to about 400 nm, or about 250 nm to about 300 nm.

In the anodeless electrode 1000 according to Example 1-1, the conductive flexible thin-film layer 300 may fill a gap that is formed because the current collector 100 and the solid electrolyte 200 do not make a close contact at an interface therebetween. Accordingly, the anodeless electrode 1000 may exhibit uniform deposition of lithium and stable charging/discharging behaviors, and reduce specific capacity decrease even at high current densities.

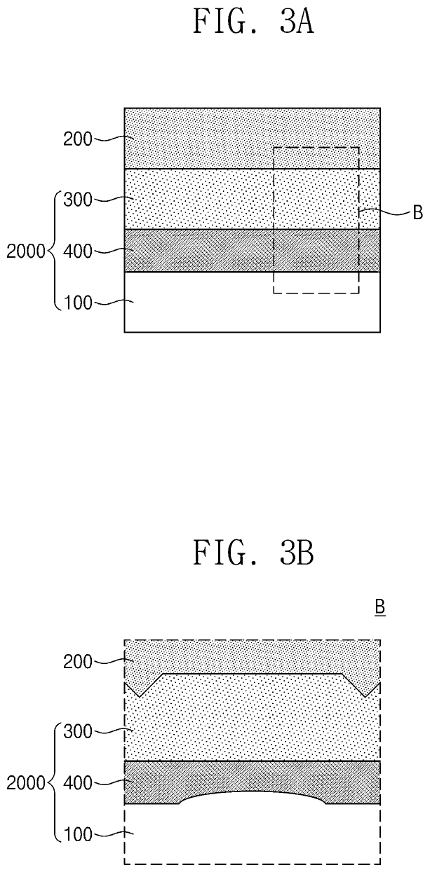

FIG. 3A illustrates a cross section of an anodeless electrode according to Example 1-2 on which a solid electrolyte is stacked. FIG. 3B is an enlarged view of region B of FIG. 3A. Except for contents to be described below, the contents duplicated with those described with the references to FIGS. 2A and 2B will be omitted.

Referring to FIGS. 3A and 3B, an anodeless electrode 2000 according to Example 1-2 may further include, on a current collector 100, a lithium-containing layer 400 with an extremely small amount of lithium. A conductive flexible thin-film layer 300 may be formed on the lithium-containing layer 400 with an extremely small amount of lithium. That is, when a solid electrolyte 200 is formed on the anodeless electrode 2000, the conductive flexible thin-film layer 300 may be disposed between the current collector 100 and the solid electrolyte 200, and the lithium-containing layer 400 with an extremely small amount of lithium may be disposed between the current collector 100 and the conductive flexible thin-film layer 300.

The lithium-containing layer 400 with an extremely small amount of lithium may include lithium or a lithium compound. The lithium compound may include at least one of lithium chloride (LiCl), lithium aluminum hydride (LiAlH₄), lithium borohydride (LiBH), lithium bromide (LiBr), lithium fluoride (LiF), lithium iodide (LiI), or lithium perchlorate (LiClO₄). The lithium-containing layer 400 with an extremely small amount of lithium may have a thickness of about 100 nm to about 10 μm, or about 500 nm to about 1 μm.

A thickness of the lithium-containing layer 400 with an extremely small amount of lithium may be determined in relation to a total capacity of a positive electrode 500. Specifically, the lithium-containing layer 400 with an extremely small amount of lithium may have a thickness satisfying the condition that an N/P ratio, which is a value obtained by dividing the total capacity of the negative electrode by the total capacity of the positive electrode 500, is less than about 0.1. That is, the lithium-containing layer 400 with an extremely small amount of lithium may have a thickness ensuring that the N/P ratio, which is a ratio of the charging capacity of the anodeless electrode to the charging capacity of the positive electrode 500, satisfies the following Expression 1.

$$0 < a / b < 0.1 \qquad Expression ( 1 )$$

Here, the N/P ratio is represented by a/b where a denotes the charging capacity (mAh) of the anodeless electrode, and b denotes the charging capacity (mAh) of the composite positive electrode.

The anodeless electrode 2000 according to Example 1-2 may exhibit uniform deposition of lithium and stable charging/discharging behaviors, and reduce specific capacity decrease even at high current densities.

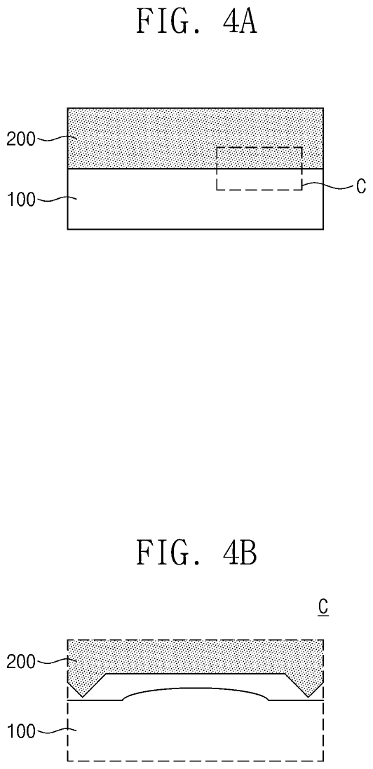

FIG. 4A illustrates a cross section of an anodeless electrode according to Comparative Example 1-1 on which a solid electrolyte is stacked. FIG. 4B is an enlarged view of region C of FIG. 4A.

Referring to FIGS. 4A and 4B, the anodeless electrode of Comparative Example 1-1 may not include the conductive flexible thin-film layer 300. That is, a solid electrolyte 200 may be formed on the anodeless electrode composed of a current collector 100. In this case, a gap may be formed because the current collector 100 and the solid electrolyte 200 do not make a close contact at an interface therebetween. Accordingly, unlike the anodeless electrode 1000 according to Example 1-1 and the anodeless electrode 2000 according to Example 1-2, which are described above in detail, the anodeless electrode according to Comparative Example 1-1 may exhibit non-uniform deposition of lithium, unstable charging/discharging behaviors, and rapid decrease in specific capacity at high current densities, due a high nucleation overvoltage.

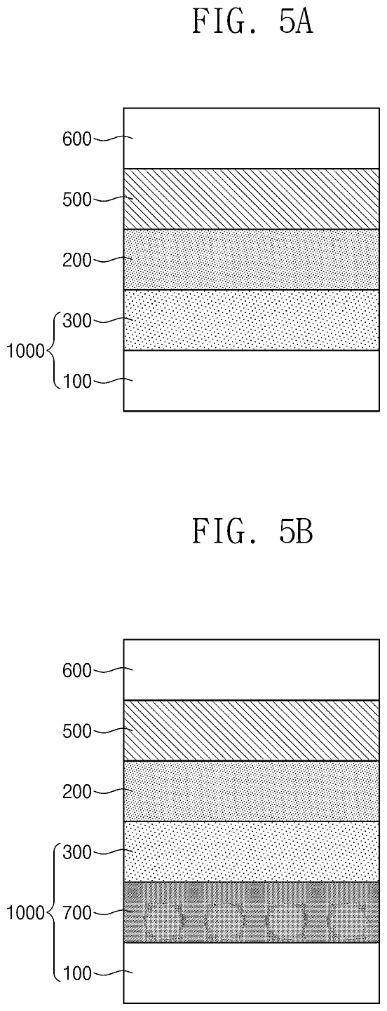

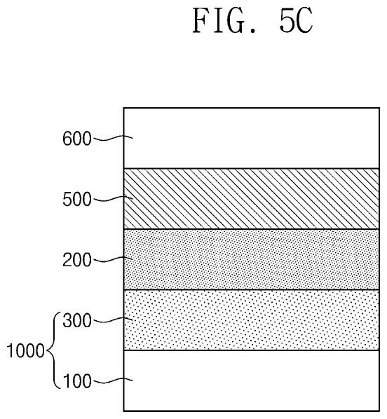

FIG. 5A illustrates a cross section of an all-solid-state full battery according to Example 3-1. FIG. 5B illustrates a cross section of an all-solid-state full battery according to Example 3-1 after being charged once. FIG. 5C illustrates a cross section of an all-solid-state full battery after being charged and discharged once according to Example 3-1. Except for contents to be described below, the description duplicated with those described with the references to FIGS. 2A and 2B will be omitted.

Referring to FIGS. 5A, 5B and 5C, in an all-solid-state full battery according to Example 3-1, a solid electrolyte 200 may be disposed on the anodeless electrode 1000 according to Example 1-1. A positive electrode 500 may be disposed on the solid electrolyte 200, and a positive electrode current collector 600 may be disposed on the positive electrode 500.

The positive electrode 500 may be a composite positive electrode including a solid electrolyte which is the same as the solid electrolyte 200 of the all-solid-state full battery. The positive electrode 500 may contain a positive electrode active material, a solid electrolyte, and a binder.

The solid electrolyte may be contained in an amount of about 10 wt % to about 30 wt %, or about 20 wt % to about 25 wt % with respect to a weight of the positive electrode. The binder may be contained in an amount of about 1 wt % to about 5 wt %, or about 1 wt % to about 2 wt % with respect to a weight of a positive electrode. In this case, the positive electrode active material may have a conductivity of about 100 S/cm or more at about 20° C.

When the positive electrode active material has a conductivity of less than about 100 S/cm at about 20° C., the positive electrode of the all-solid-state full battery may further include a conductive material. The conductive material may be contained in an amount of about 1 wt % to about 5 wt %, or about 1 wt % to about 2 wt % with respect to a weight of the positive electrode.

In the positive electrode 500, a weight of the positive electrode active material may be a remaining weight excluding the weights of the solid electrolyte, the binder, and the conductive material.

The positive electrode active material may include at least one of lithium cobalt oxide (LiCoO₂), lithium nickel oxide (LiNiO₂), lithium manganese oxide (LiMnO₄), lithium nickel cobalt aluminum oxide (LiNiCoAlO₂), olivine (LiFePO₄), or lithium cobalt manganese nickel oxide (LiCoₓMn_{y}Ni_{z}O₂; x+y+z=1). The positive electrode active material may include a mixture or solid solution of the above-described compounds.

A coating layer may be applied on a surface of the positive electrode active material. The coating layer may prevent the positive electrode active material and the solid electrolyte from being in direct contact with each other in the composite positive electrode. This then makes it possible to reduce occurrence of inherent side reactions and prevent degradation of battery performances. The coating layer may include at least one of Li₄Ti₅O₁₂, LiNbO₃, Ta₂O₅, LiTaO₃, Li₄SiO₄, Li₄GeO₄, Li_{3.5}Ge_{0.5}P_{0.5}O₄, Li₃PO₄, Li═O—ZrO₂, or Li₃₋ₓB₁₋ₓCₓO₃ (0≤x≤1).

The binder may include at least one of polyvinylidene fluoride, polyimide, polytetrafluoroethylene, poly (ethylene oxide), polyacrylonitrile, hydroxypropyl cellulose, carboxymethyl cellulose, Na-carboxymethyl cellulose, styrene-butadiene rubber, or nitrile-butadiene rubber.

A compound, which has conductivity as well as light weight, may be used as the conductive material. For example, the conductive material may include at least one of graphite, hard/soft carbon, carbon fiber, carbon nano tube, linear carbon, carbon black (for example, Super-P), acetylene black, or Ketjen black.

As illustrated in FIGS. 2A and 2B, the conductive flexible thin-film layer 300 may fill the interface at which the current collector 100 and the solid electrolyte 200 are not in a close contact with each other. Accordingly, as illustrated in FIG. 5B, when a battery is charged once, a lithium deposition layer 700 may be uniformly disposed between the conductive flexible thin-film layer 300 and the current collector 100. Referring to FIG. 5C, when the battery is charged and discharged once, the lithium deposition layer 700 disappears. As result, the all-solid-state full battery according to Example 3-1 may exhibit uniform deposition of lithium and stable charging/discharging behaviors, and reduce specific capacity decrease even at high current densities.

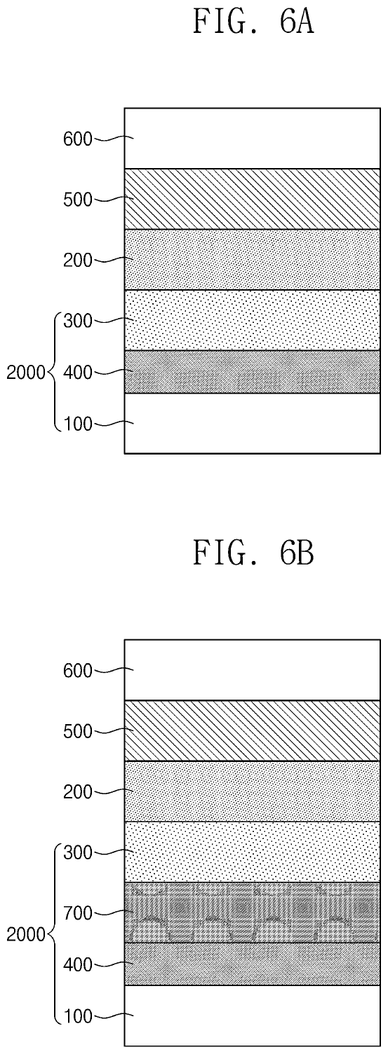

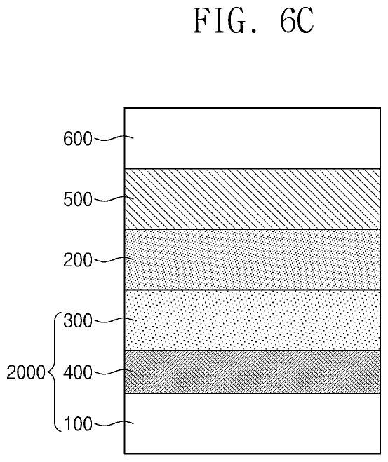

FIG. 6A illustrates a cross section of an all-solid-state full battery according to Example 3-2. FIG. 6B illustrates a cross section of the all-solid-state full battery according to Example 3-2 after being charged once. FIG. 6C illustrates a cross section of the all-solid-state full battery according to Example 3-2 after being charged and discharged once. Except for contents to be described below, the description duplicated with those described with the references to FIGS. 3A, 3B, 5A, 5B, and 5C will be omitted.

In an all-solid-state full battery according to Example 3-2, a solid electrolyte 200 may be formed on the anodeless electrode 2000 according to Example 1-2. A positive electrode 500 may be formed on the solid electrolyte 200, and a positive electrode current collector 600 may be formed on the positive electrode 500. As similar to the all-solid-state full battery according to Example 3-1, when the all-solid-state full battery according to Example 3-2 is charged once, the lithium deposition layer 700 is uniformly disposed between the conductive flexible thin-film layer 300 and the current collector 100, and when the all-solid-state full battery according to Example 3-2 is charged and discharged once, the lithium deposition layer 700 disappears. The all-solid-state full battery according to Example 3-2 may exhibit uniform deposition of lithium and stable charging/discharging behaviors, and reduce specific capacity decrease even at high current densities.

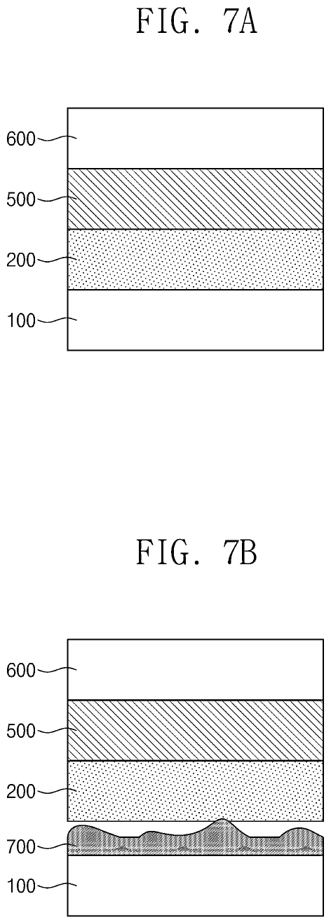

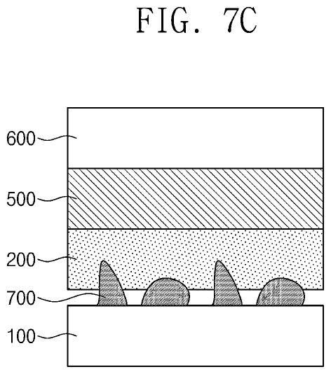

FIG. 7A illustrates a cross section of an all-solid-state full battery according to Comparative Example 3-1. FIG. 7B illustrates a cross section of the all-solid-state full battery according to Comparative Example 3-1 after being charged once. FIG. 7C illustrates a cross section of the all-solid-state full battery according to Comparative Example 3-1 after being charged and discharged once.

Referring to FIGS. 7A, 7B, and 7C, in the all-solid-state full battery according to Comparative Example 3-1, a solid electrolyte 200 may be formed on a current collector 100, and a positive electrode 500 and a positive electrode current collector 600 may be formed on the solid electrolyte 200. A gap may be formed because the current collector 100 and the solid electrolyte 200 do not make a close contact at an interface therebetween. This makes a lithium deposition layer 700 be non-uniformly disposed between the current collector 100 and the solid electrolyte 200. The non-uniform lithium deposition layer 700 may not disappear but remain when being charged and discharged once. As a result, unlike the all-solid-state full battery according to Example 3-1 and the all-solid-state full battery according to Example 3-2, which are described above in detail, the all-solid-state full battery according to Comparative Example 3-1 may exhibit non-uniform deposition of lithium, unstable charging/discharging behaviors, and rapid decrease in specific capacity at high current densities, etc., due to high nucleation overvoltage.

### <Preparation of Anodeless Electrode>

### Example 1-1

Poly (3,4-ethylene dioxythiophene): polyphenylene (PEDOT: PSS) was selected as a conductive polymer, styrene butadiene rubber (SBR) was selected as a soft polymer, and an Ag nanoparticle was selected as a metal nanoparticle.

A PEDOT: PSS solution (a weight ratio is about 1.3 wt %, and a solvent is water), and an SBR solution (a weight ratio is about 40 wt %, and a solvent is water) were mixed at a weight ratio of 100:40 to prepare a polymer blend in which the two polymers are uniformly mixed.

An organic-inorganic blend was prepared by mixing about 40 parts by weight of Ag nanoparticles with respect to 100 parts by weight of the polymer blend to be uniformly dispersed.

A SUS substrate having a thickness of about 10 μm was treated with ozone for about 10 minutes, and then was spin-coated with about 5 ml of the organic-inorganic blend at about 500 rpm for about 10 seconds, and at about 1000 rpm for about 120 seconds. A conductive flexible thin-film layer having a thickness of about 300 nm was coated on the SUS substrate. The anodeless electrode was prepared through a primary drying process at about 80° C. for about 30 minutes on a hot plate, and a secondary process at about 80° C. for about 12 hours under vacuum in a vacuum oven.

### Example 1-2

An anodeless electrode was prepared tin the same manner as in Example 1-1, except that a lithium-containing layer with an extremely small amount of lithium having a thickness of about 700 nm was formed on the SUS substrate.

### Comparative Example 1-1

An anodeless electrode was prepared, in which any treatment was not performed on the SUS substrate.

### Comparative Example 1-2

An anodeless electrode was prepared in the same manner as in Example 1-1, except that the Ag nanoparticles were not included in the conductive flexible thin-film layer.

<Manufacture of all-Solid-State Half Battery>

### Example 2-1

An all-solid-state half battery composed of an anodeless electrode, a solid electrolyte, and lithium metal was manufactured using the anodeless electrode according to Example 1-1. An azirodite-based L₆PS₅Cl (LPSCl) compound was used as the solid electrolyte.

About 150 mg of LPSCl powder was subjected cold sintering under a pressure of about 80 MPa to prepare the solid electrolyte layer in a pellet-like form. The all-solid-state half battery was manufactured by forming, on both sides of the solid electrolyte layer, the anodeless electrode according to Example 1 and lithium metal having a thickness of about 300 μm.

### Example 2-2

An all-solid-state half battery was manufactured in the same manner as in Example 2-1, except that the anodeless electrode according to Example 1-2 was used.

### Comparative Example 2-1

An all-solid-state half battery was manufactured in the same manner as in Example 2-1, except that the anodeless electrode according to Example 1-1 was used.

### Comparative Example 2-2

An all-solid-state half battery was manufactured in the same manner as in Example 2-1, except that the anodeless electrode according to Example 1-2 was used.

<Manufacture of all-Solid-State Full Battery>

### Example 3-1

An all-solid-state full battery composed of an anodeless electrode, a solid electrolyte, and a composite positive electrode was manufactured using the anodeless electrode according to Example 1-1. An azirodite-based L₆PS₅Cl (LPSCl) compound was used as the solid electrolyte.

To prepare a composite positive electrode, a binder solution was prepared by dissolving about 8 wt % (weight ratio) of nitrile butadiene rubber (NBR) of in anisole (C₇H₈O) and stirring the mixture for about 12 hours.

LiNi_{0.6}Mn_{0.2}Co_{0.2}O₂ (hereinafter, NMC622) coated with LiNbO₃ was used as a positive electrode active material, and Super-P was used as a conductive material.

A slurry was prepared by weighing NMC622, LPSCl, a conductive material and a binder at a ratio of 60:35:3:2, and mixing the resultant mixture. After the slurry was coated on a Ni foil using a doctor blade, the coated slurry was primarily dried in a hot air blower at about 100° C. for about 1 hour, and was secondarily dried in a vacuum oven at about 100° C. for about 12 hours. A loading level of the active material was about 0.015 mg/cm², which corresponds to a capacity of about 2 mAh/cm², and finally, the composite positive electrode was prepared through the above-described process.

About 150 mg of LPSCl powder of was subjected to cold sintering under a pressure of about 80 MPa to prepare the solid electrolyte layer in a pellet-like form. The all-solid-state full battery was manufactured by forming, on both sides of the solid electrolyte layer, the anodeless electrode according to Example 1-1 and the above-described composite positive electrode, and then applying a pressure of about 250 MPa to the resultant to be integrally formed.

### Example 3-2

An all-solid-state full battery was manufactured in the same manner as in Example 3-1, except that the anodeless electrode according to Example 1-2 was used.

### Comparative Example 3-1

An all-solid-state full battery was manufactured in the same manner as in Example 3-1, except that the anodeless electrode according to Comparative Example 1-1 was used.

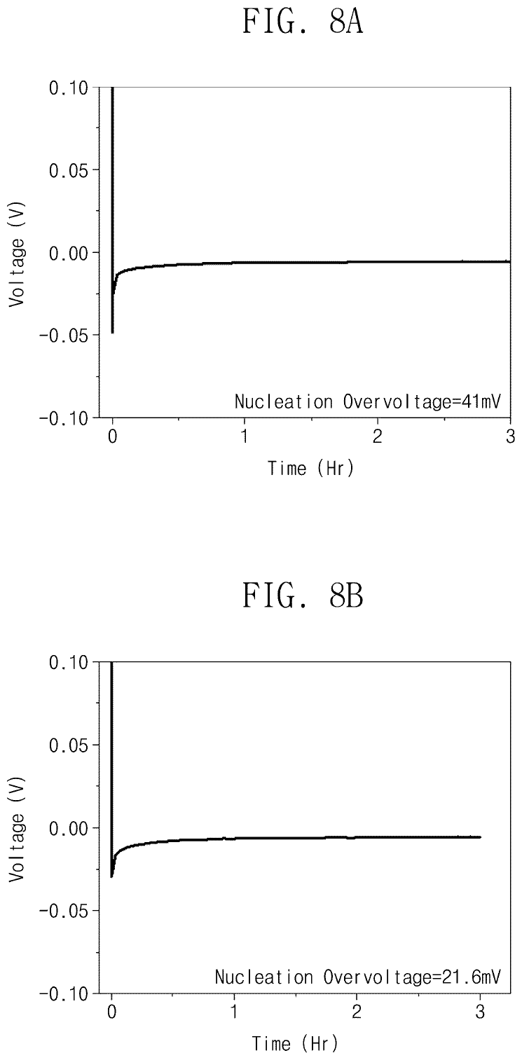

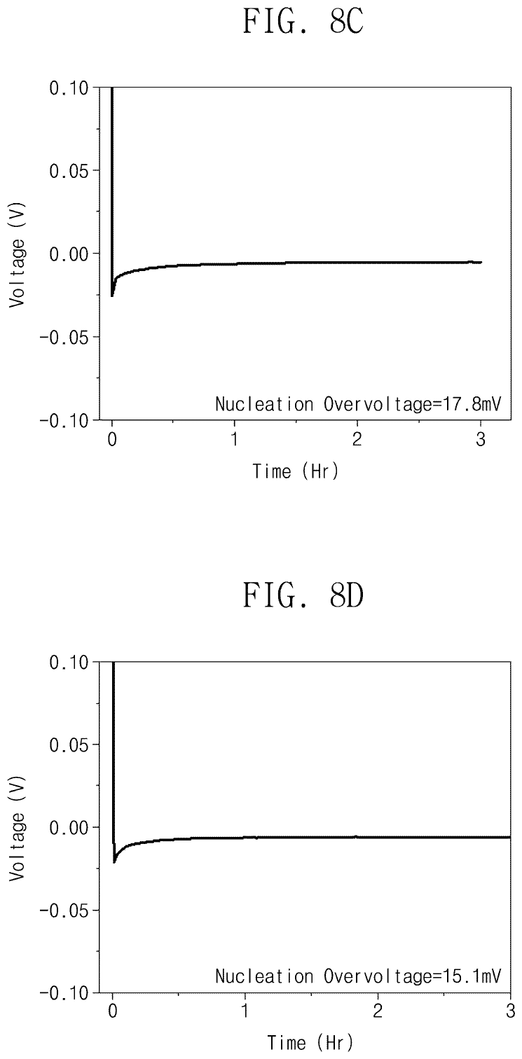

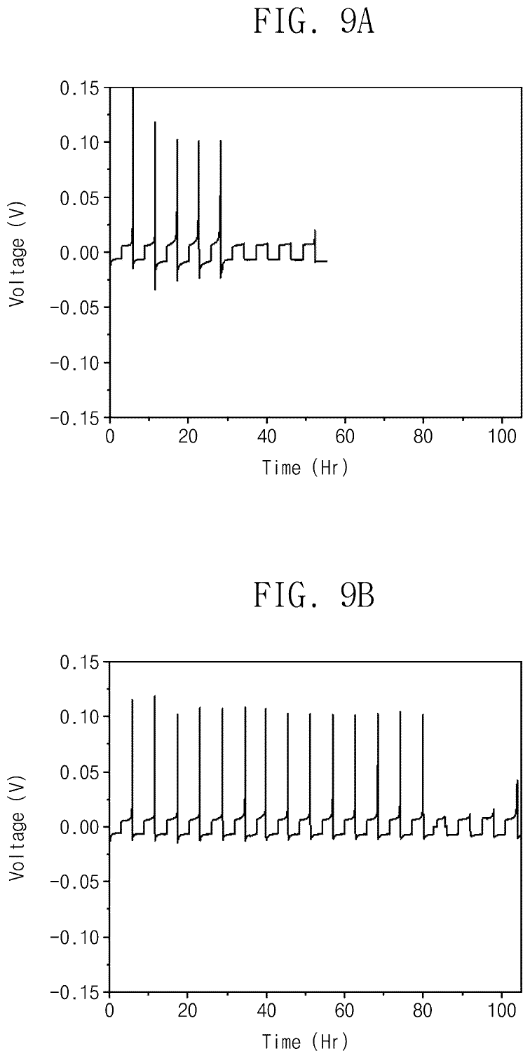

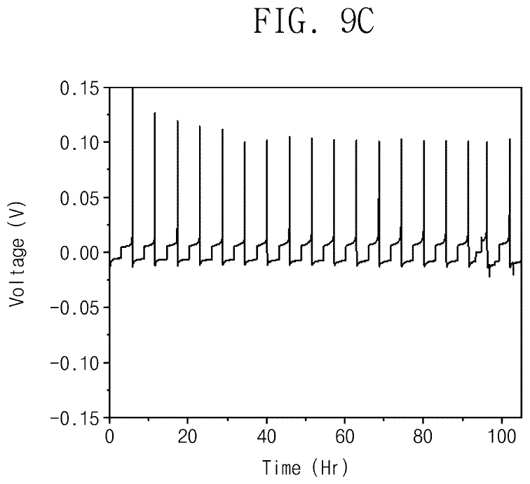

Table 1 shows results of nucleation overvoltages at a first cycle during the operations of all-solid-state half batteries of Example 2-1, Example 2-2, Comparative Example 2-1, and Comparative Example 2-2. FIGS. 8A, 8B, 8C, and 8D respectively show the results of nucleation overvoltages at the first cycle during the operations of the all-solid-state half batteries of Example 2-1, Example 2-2, Comparative Example 2-1, and Comparative Example 2-2. FIGS. 9A, 9B, and 9C respectively show results of voltage curves according to time elapse during the charging and discharging of all-solid-state half batteries of Example 2-1, Comparative Example 2-1, and Comparative Example 2-2.

To analyze charging and discharging properties, charging and discharging each were carried out for about 3 hours at a current density of about 0.5 mA/cm² based on a CC mode. Here, the discharging means a reaction in which lithium is deposited on the anodeless electrode, and the charging means a reaction in which lithium is desorbed from the anodeless electrode. Capacities of charging and discharging were set to about 1.5 mAh/cm², and a cut-off voltage during discharging was set to about 0.1 V. The evaluation of charging and discharging was conducted at a temperature of about 60° C.

TABLE 1

| | Nucleation Overvoltage (mV) |
|---|---|
| Example 2-1 | 17.8 |
| Example 2-2 | 15.1 |
| Comparative Example 2-1 | 41 |
| Comparative Example 2-2 | 21.6 |

The higher the nucleation overvoltage is, the more non-uniform deposition of lithium occurs. Referring to FIGS. 8A, 8B, 8C, 8D, and Table 1, it may be seen that the all-solid-state half battery including the anodeless electrode including the conductive flexible thin-film layer 300 according to the inventive concept has a nucleation overvoltage of less than about 18 mV. Additionally, it may be confirmed that the all-solid-state half battery including the anodeless electrode including the conductive flexible thin-film layer 300 and the lithium-containing layer 400 with an extremely small amount of lithium according to the inventive concept has a nucleation overvoltage of less than about 15.5 mV, and thus lithium dendrites may be effectively prevented.

Referring to FIGS. 9A, 9B, and 9C, it may be confirmed that the all-solid-state half battery according to Example 2-1 exhibits stable charging/discharging behaviors more than those according to Comparative Example 2-1 and Comparative Example 2-2.

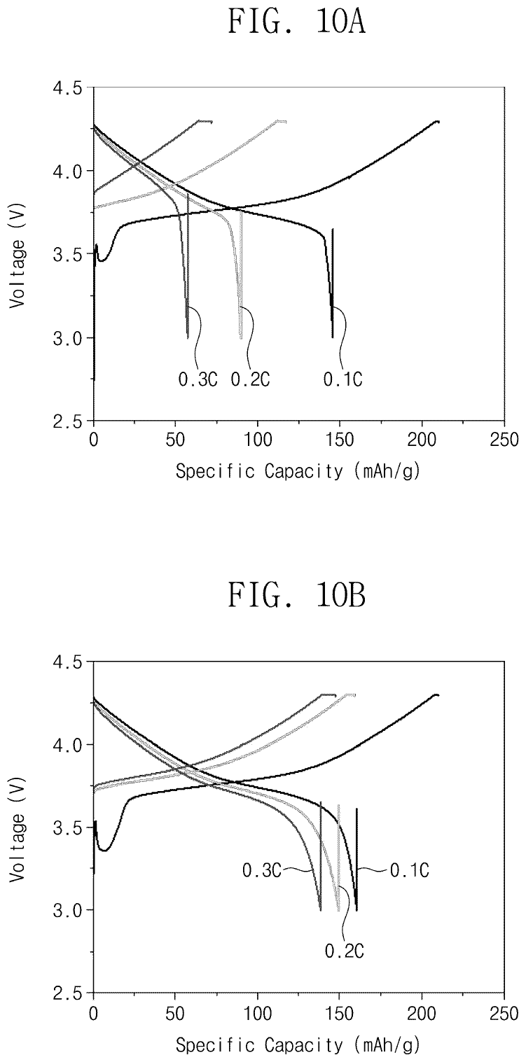

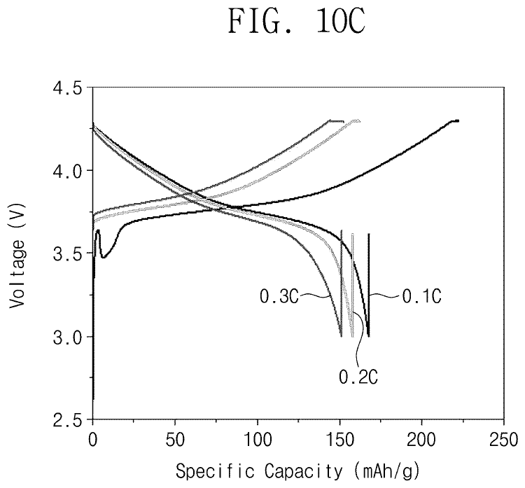

FIGS. 10A, 10B, and 10C show voltage change curves according to specific capacities of the all-solid-state full batteries according to Comparative Example 3-1, Example 3-1, and Example 3-2 at various current densities (an active material-based loading capacity: about 2.0 mAh/cm²). Table 2 shows specific capacities (mAh/g) of the all-solid-state batteries of FIGS. 10A, 10B, and 10C at current densities of 0.1 C, 0.2 C, and 0.3 C.

TABLE 2

| | Current Density | | |
|---|---|---|---|
| | 0.1 C | 0.2 C | 0.3 C |
| Example 3-1 | 160.52 mAh/g | 149.54 mAh/g | 138.45 mAh/g |
| Example 3-2 | 167.68 mAh/g | 157.96 mAh/g | 151.19 mAh/g |
| Comparative | 145.65 mAh/g | 117.30 mAh/g | 72.00 mAh/g |
| Example 3-1 | | | |

As shown in FIGS. 10A, 10B, 10C, and Table 2, it may be confirmed that in Comparative Example 3-1, the specific capacity of the all-solid-state full battery including the current collector 100 alone rapidly decreases as the current densities increase. On the other hand, it may be confirmed that the all-solid-state full battery according to Example 3-1 including the conductive thin film flexible layer according to the inventive concept has a specific capacity of more than about 149 mAh/g at 0.2 C, and a specific capacity of more than about 138 mAh/g even at 0.3 C, and the specific capacity thereof was not rapidly decreased. It may be confirmed that the all-solid-state full battery according to Example 3-2 including the conductive thin film flexible layer 300 and the lithium-containing layer 400 with an extremely small amount of lithium according to inventive concept has a specific capacity of more than about 157 mAh/g at 0.2 C and more than about 151 mAh/g at 0.3 C, and a decrease in specific capacity thereof was not sharper than that of the all-solid-state full battery according to Example 3-1.

An anodeless electrode according to an embodiment of the inventive concept may include a conductive flexible thin-film layer including a conductive polymer, a soft polymer, and metal nanoparticles. The conductive polymer may maintain an electrode and a solid electrolyte to make a close contact with each other at an interface therebetween. The soft polymer may improve mechanical strength of the anodeless electrode. The metal nanoparticles may increase an absorption rate of lithium ions during charging and discharging.

The effects according to an embodiment of the inventive concept are not limited thereto, and other effects not mentioned above will be fully understood by one ordinary skilled in the art from the description below.

In the above, embodiments of the inventive concept have been described with reference to the attached drawings, but the inventive concept may be implemented in other specific forms without departing from the technical spirit or modifying essential features. Therefore, it should be understood that all the above-described embodiments are exemplarily illustrated and are not limited thereto.

What is claimed is:

1. An anodeless electrode comprising:
a current collector; and
a conductive flexible thin-film layer disposed on the current collector,
wherein the conductive flexible thin-film layer includes a conductive polymer, a soft polymer, and metal nanoparticles, and
the metal nanoparticles have a diameter of about 20 nm to about 100 nm, and are contained in an amount of about 20 wt % to about 50 wt % with respect to the sum of weights of the conductive polymer and the soft polymer.

2. The anodeless electrode of claim 1, wherein the current collector comprises at least one of copper, aluminum, nickel, stainless steel, titanium, or zinc.

3. The anodeless electrode of claim 1, wherein the conductive polymer comprises at least one of polypyrrole (PPy), polyaniline (PANi), polythiophene (PT), poly (3,4-ethylene dioxythiophene (PEDOT), polyphenylene (PSS), poly (p-phenylene vinylene (PPV), polyacetylene (PAc), poly (3-alkylthiophene (P3ATs), or polyfuran (Pfu).

4. The anodeless electrode of claim 1, wherein the soft polymer comprises at least one of butadiene rubber, fluorine-based rubber, nitrile butadiene rubber, hydrogenated nitrile butadiene rubber, styrene butadiene rubber, styrene butadiene styrene, styrene ethylene butadiene styrene, acrylated styrene butadiene rubber, or an acrylonitrile butadiene styrene copolymer.

5. The anodeless electrode of claim 1, wherein the metal nanoparticles comprise at least one of gold, silver, platinum, palladium, iron, cobalt, zinc, aluminum, tungsten, or silicon.

6. The anodeless electrode of claim 1, further comprising a lithium layer, wherein the lithium layer is disposed between the current collector and the conductive flexible thin-film layer, and has a thickness of about 100 nm to about 1 μm.

7. The anodeless electrode of claim 1, wherein the soft polymer is contained in an amount of about 20 wt % to about 50 wt % with respect to a weight of the conductive polymer.

8. The anodeless electrode of claim 1, wherein the conductive flexible thin-film layer has a thickness of about 50 nm to about 500 nm.

9. A secondary battery comprising:
an anodeless electrode including a current collector, and a conductive flexible thin-film layer disposed on the current collector;
a composite positive electrode; and
a solid electrolyte disposed between the anodeless electrode and the composite positive electrode,
wherein the conductive flexible thin-film layer includes a conductive polymer, a soft polymer, and metal nanoparticles, and
the metal nanoparticles have a diameter of about 20 nm to about 100 nm, and are contained in an amount of about 20 wt % to about 50 wt % with respect to the sum of weights of the conductive polymer and the soft polymer.

10. The secondary battery of claim 9, wherein the anodeless electrode further comprises a lithium layer,
the lithium layer is disposed between the current collector and the conductive flexible thin-film layer, and
a ratio of a charging capacity of the anodeless electrode and a charging capacity of the composite positive electrode satisfies the following Expression (1):
$$0 < a / b < 0.1 \qquad Expression ( 1 )$$
where a denotes the charging capacity (mAh) of the anodeless electrode, and b denotes the charging capacity (mAh) of the composite positive electrode.

11. A method for manufacturing an anodeless electrode, the method comprising:
preparing a polymer blend by mixing a conductive polymer and a soft polymer;
preparing a composite blend by mixing metal nanoparticles with the polymer blend; and
coating a current collector with the composite blend,
wherein the metal nanoparticles have a diameter of about 20 nm to about 100 nm,
the soft polymer is mixed in an amount of about 20 wt % to about 50 wt % with respect to a weight of the conductive polymer, and
the metal nanoparticles are mixed in an amount of about 20 wt % to about 50 wt % with respect to a weight of the polymer blend.

12. The method of claim 11, wherein the composite blend has a thickness of about 50 nm to about 500 nm.
